(19) United States
(12) Patent Application Publication
(10) Pub. No.: US 2025/0239181 A1
(43) Pub. Date: Jul. 24, 2025

(54) CHEST WOUNDS FOR PATIENT SIMULATORS

(71) Applicant: GAUMARD SCIENTIFIC COMPANY, INC., Miami, FL (US)

(72) Inventors: Julio FERRER, Miami, FL (US); Arian HERNANDEZ, Miami, FL (US)

(21) Appl. No.: 19/030,167

(22) Filed: Jan. 17, 2025

Related U.S. Application Data
(60) Provisional application No. 63/623,183, filed on Jan. 19, 2024.

(51) Int. Cl. G09B 23/30

(52) U.S. Cl. CPC G09B 23/303

(57) ABSTRACT

Simulated chest wounds for patient simulators and associated devices, systems, and methods are provided. In some instances, a patient simulator comprises a simulated torso having a recess and a chest wound assembly positioned within the recess of the simulated torso, the chest wound assembly comprising a cavitation fitting having a plurality of fingers defining a plurality of slits in communication with an opening of the chest wound assembly, the cavitation fitting in fluid communication with a reservoir of simulated blood and configured to produce bubbles and cavitation noises as the simulated blood is circulated to and from the chest wound assembly.

### CROSS-REFERENCE TO RELATED APPLICATIONS

The present application claims priority to and the benefit of U.S. Provisional Patent Application No. 63/623,183, filed Jan. 19, 2024, which is hereby incorporated by reference in its entirety for all applicable purposes.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. Nos. 11,756,451, 8,696,362, 8,016,598, 7,976,312, U.S. Pat. No. 7,976,313, U.S. patent application Ser. No. 11/952,669 (Publication No. 20090148822), U.S. Pat. Nos. 7,114,954, 6,758,676, 6,503,087, 6,527,558, 6,443,735, 6,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes chest wounds for patient simulators. In this regard, the chest wounds of the current disclosure can provide realistic simulation of open chest wounds. Open chest wounds can result from a disruption, break, cavity, and/or other opening in the chest wall, permitting external air entry into the pleural space. These injuries manifest in various scenarios such as accidents, trauma incidents, terrorist attacks, and/or combat situations. Notably, open chest wounds are known for the production of cavitation noises upon air ingress into the wound, generating audible cues during the expiratory cycle. To authentically replicate this phenomenon, an engineered chest wound insert for use with patient simulators has been developed.

In some aspects, the chest wound assembly includes a silicon skin layer with an opening extending therethrough. A cavitation fitting having a plurality of fingers defining a plurality of slits is in communication with the opening of the chest wound insert and in fluid communication with a pump and/or reservoir(s) that provide simulated blood to the cavitation fitting. In this regard, the cavitation fitting is configured to produce bubbles and cavitation noises (e.g., sucking noises) as the simulated blood is circulated to and from the chest wound assembly. For example, simulated blood, capable of creating bubbles, may be propelled to the chest wound assembly by a positive displacement pump. As the simulated blood traverses the system, air trapped within the slit cuts of the cavitation fitting produces bubbles, creating a dynamic bubbling effect commonly associated with open chest wounds. During the pump's suction phase, a mixture of air and blood may be drawn back into a reservoir within the chest wound assembly and/or an associated reservoir (e.g., a coiled tubing reservoir coupled to the chest wound assembly). In some aspects, it has been observed that the quantity of bubbles generated by the chest wound assembly is associated with (e.g., directly proportional or otherwise related) to the number of cuts or slits in the cavitation fitting.

In some instances, a patient simulator comprises: a simulated torso having a recess; and a chest wound assembly positioned within the recess of the simulated torso, the chest wound assembly comprising a cavitation fitting having a plurality of fingers defining a plurality of slits in communication with an opening of the chest wound assembly, the cavitation fitting in fluid communication with a reservoir of simulated blood and configured to produce bubbles and cavitation noises as the simulated blood is circulated to and from the chest wound assembly. The patient simulator may further comprise a pump in communication with the reservoir of simulated blood. The pump may be configured to circulate the simulated blood between the reservoir and the chest wound assembly. The pump may be a positive displacement pump. The positive displacement pump may be configured to draw in a mixture of air and blood into a volume associated with the chest wound assembly during a suction cycle. The volume may include a coiled tubing reservoir coupled to the chest wound assembly. The volume may include a reservoir within the chest wound assembly. The plurality of fingers may define a plurality of slits between 4 slits and 100 slits, including between 5 slits and 15 slits. The opening may extend from the cavitation fitting through a simulated skin layer to a simulated skin surface of the chest wound assembly. The simulated skin layer and the cavitation fitting may be coupled to a base component, wherein the base component is sized and shaped to fit within the recess of the simulated torso.

In some instances, a chest wound assembly for a patient simulator comprises: base component; a cavitation fitting coupled to the base component, the cavitation fitting having a plurality of fingers defining a plurality of slits; and a skin layer coupled to the base component and the cavitation fitting, wherein an opening extends through the skin layer from a simulated skin surface to the cavitation fitting; wherein the cavitation fitting is configured to be in fluid communication with a reservoir of simulated blood and configured to produce bubbles and cavitation noises as simulated blood is circulated to and from the chest wound assembly. The chest wound assembly may further comprise a pump configured to be in communication with the reservoir of simulated blood. The pump may be configured to circulate the simulated blood between the reservoir and the chest wound assembly. The pump may be a positive displacement pump. The positive displacement pump may be configured to draw in a mixture of air and blood into a volume associated with the chest wound assembly during a suction cycle. The volume may include a coiled tubing reservoir coupled to the chest wound assembly and/or a reservoir within the chest wound assembly. The base component may be sized and shaped to fit within a recess of the patient simulator. The chest wound assembly may further comprise the reservoir of simulated blood.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator including a simulated torso, a simulated head, a simulated neck, a simulated right arm, a simulated left arm, a simulated right leg, and a simulated left leg, including at least one pelvic wound assembly according to one or more aspects of the present disclosure.

FIG. 2 is a perspective view of a chest wound assembly, according to one or more aspects of the present disclosure.

FIG. 3 is a cross-sectional side view of the chest wound assembly of FIG. 2, according to one or more aspects of the present disclosure.

FIG. 4 is a perspective view of a portion of the chest wound assembly of FIGS. 2-3, according to one or more aspects of the present disclosure.

FIG. 5 is a perspective top view of a cavitation fitting of the chest wound assembly of FIGS. 2-4, according to one or more aspects of the present disclosure.

FIG. 6 is a perspective view of a chest wound assembly coupled with a coiled tubing reservoir, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard surgical instruments in a simulated patient treatment situation.

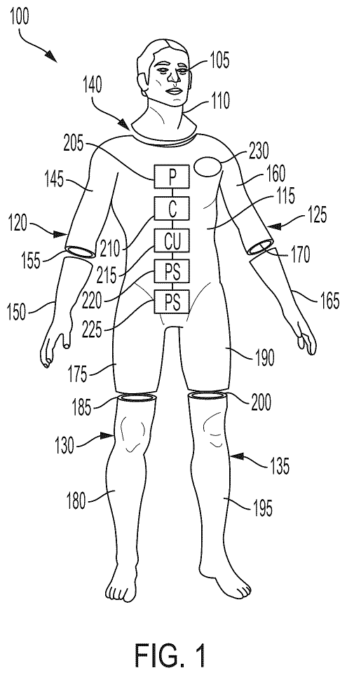

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170.

The simulated right leg 130 may include a simulated upper right leg 175 (or “extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, chest wound assembl(ies) 230, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas. In some instances, one or more chest wound assemblies 230 may be associated with one or more of the pump(s) 205, compressor(s) 210, and/or reservoir(s) 220 to control the flow of fluid and/or gas into and/or through the chest wound assemblies 230 for one or more simulation scenarios.

The control unit(s) 215 may be adapted to control the pump(s) 205, the compressor(s) 210, the reservoir(s) 220, including one or more valves associated with the pump(s), compressor(s), and/or reservoir(s), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO₂, etc.). The reservoir(s) 220 may include a single compartment or multiple compartments. The reservoir(s) 220 may be associated with one or more valves to control the flow of fluid and/or gas into and/or out of the reservoir(s) 220 (e.g., to and/or through the chest wound assemblies 230).

The power source(s) 225 may supply electrical power to the pump(s) 205, the compressor(s) 210, the control unit(s) 215, the reservoir(s) 220, including one or more valves associated with the pump(s), compressor(s), and/or reservoir(s), the chest wound assembl(ies) 230, and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. The features/components to which electrical power is supplied by the power source(s) 225 may be contained in a different portion of the patient simulator 100 than the power source(s) 225. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), and various other features/components). In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components).

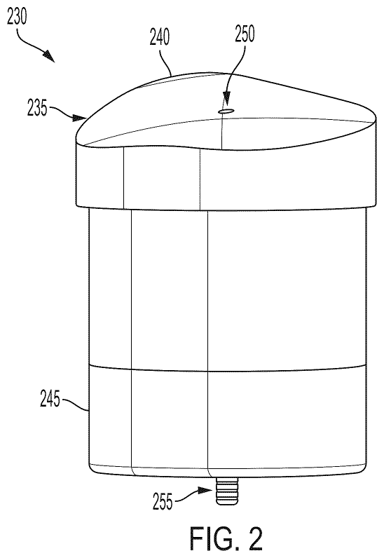

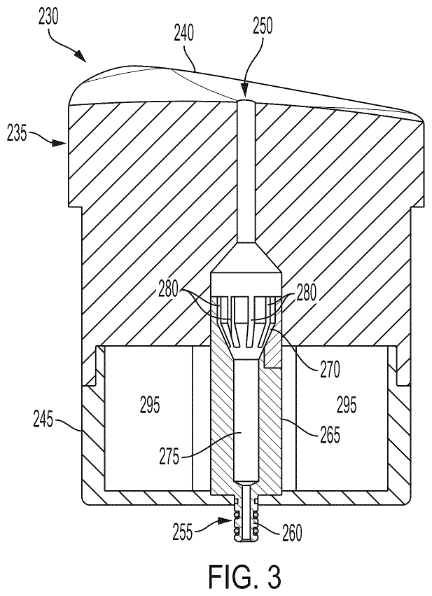

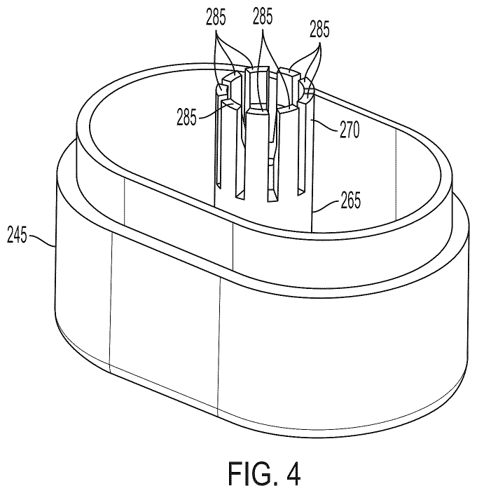

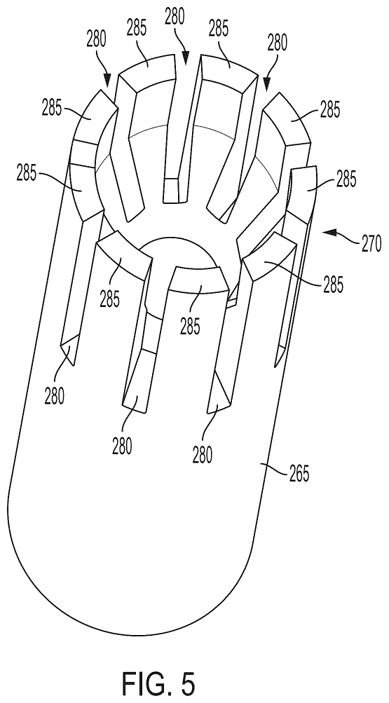

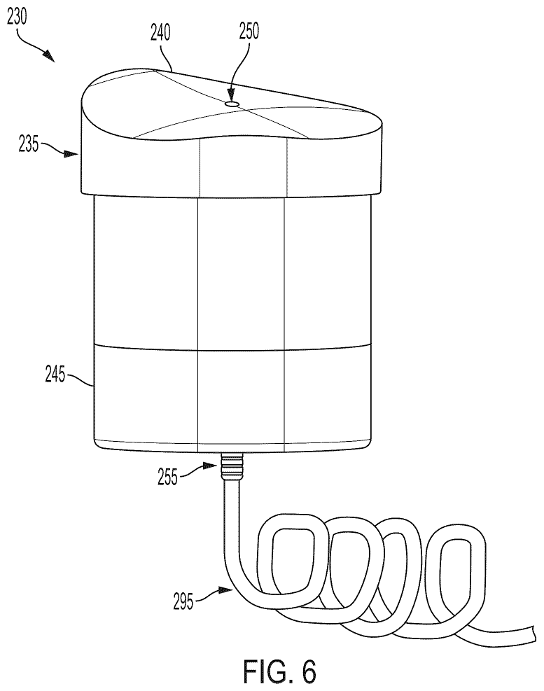

Referring to FIGS. 2-6 and continuing reference to FIG. 1, the patient simulator 100 includes one or more chest wound assemblies 230. For example, FIG. 2 is a perspective view of a chest wound assembly 230, according to one or more aspects of the present disclosure. FIG. 3 is a cross-sectional side view of the chest wound assembly 230 of FIG. 2, according to one or more aspects of the present disclosure. FIG. 4 is a perspective view of a portion of the chest wound assembly 230 of FIGS. 2-3, according to one or more aspects of the present disclosure. FIG. 5 is a perspective top view of a cavitation fitting of the chest wound assembly 230 of FIGS. 2-4, according to one or more aspects of the present disclosure. FIG. 6 is a perspective view of a chest wound assembly 230 coupled with a coiled tubing reservoir, according to one or more aspects of the present disclosure.

The chest wound assemblies of the current disclosure can provide realistic simulation of open chest wounds. Open chest wounds can result from a disruption, break, cavity, and/or other opening in the chest wall, permitting external air entry into the pleural space. These injuries manifest in various scenarios such as accidents, trauma incidents, terrorist attacks, and/or combat situations. Notably, open chest wounds are known for the production of cavitation noises upon air ingress into the wound, generating audible cues during the expiratory cycle. To authentically replicate this phenomenon, an engineered chest wound insert for use with patient simulators has been developed.

In some aspects, the chest wound assembly includes a silicon skin layer with an opening extending therethrough. A cavitation fitting having a plurality of fingers defining a plurality of slits is in communication with the opening of the chest wound insert and in fluid communication with a pump and/or reservoir(s) that provide simulated blood to the cavitation fitting. In this regard, the cavitation fitting is configured to produce bubbles and cavitation noises (e.g., sucking noises) as the simulated blood is circulated to and from the chest wound assembly. For example, simulated blood, capable of creating bubbles, may be propelled to the chest wound assembly by a positive displacement pump. As the simulated blood traverses the system, air trapped within the slit cuts of the cavitation fitting produces bubbles, creating a dynamic bubbling effect commonly associated with open chest wounds. During the pump's suction phase, a mixture of air and blood may be drawn back into a reservoir within the chest wound assembly and/or an associated reservoir (e.g., a coiled tubing reservoir coupled to the chest wound assembly). In some aspects, it has been observed that the quantity of bubbles generated by the chest wound assembly is associated with (e.g., directly proportional or otherwise related) to the number of cuts or slits in the cavitation fitting. Further, in some instances a coiled tubing is coupled to the inlet of the cavitation fitting of the chest wound assembly 230. It has been observed that including the additional coiled tubing reservoir allows for a more extensive trapping of blood, resulting in increased noise generation as the fluid is moved back and forth to and from the chest wound assembly. In this regard, the coiled tubing reservoir serves to amplify and enhance the overall acoustic realism of the open chest wound simulation scenarios.

As shown in FIGS. 2-6, the chest wound assembly 230 includes a multi-layered construction with a central cavity to simulate an open chest wound or other similar injury. The chest wound assembly 230 may be sized and shaped to fit into a corresponding recess or opening in the patient simulator 100. In some instances, the recess or opening is within the torso of the patient simulator 100 and, in some particular instances, in the chest area of the patient simulator near and/or over where the lungs would be positioned.

As shown in FIGS. 2-3, the chest wound assembly 230 includes an outer skin layer 235. The outer skin layer 235 may include a surface portion 240 that is configured to match the surrounding skin layer of the torso 115 of the patient simulator 100. In some aspects, the outer skin layer 235 may be similar to or the same as similar layers described in U.S. Pat. Nos. 11,756,451, 8,696,362, 8,016,598, 7,976,312, 7,976,313, U.S. patent application Ser. No. 11/952,669 (Publication No. 20090148822), U.S. Pat. Nos. 7,114,954, 6,758,676, 6,503,087, 6,527,558, 6,443,735, 6,193,519, and 5,853,292, each herein incorporated by reference in its entirety.

The outer skin layer 235 is coupled to a base component 245. The base component 245 may be sized and shaped to fit within a recess or opening in the chest of the patient simulator 100. The chest wound assembly includes an opening 250 extending through the outer skin layer 235 to a cavitation fitting 255. The cavitation fitting is coupled to the base component 245. The cavitation fitting 255 includes a coupling 260 that is configured to interface with a coupling, a fitting, tubing (e.g., coiled tubing reservoir 295 of FIG. 6), and/or other connector configured to provide simulated blood to the cavitation fitting 255. In this regard, the cavitation fitting 255 includes a main body 265 and an upper portion 270. An opening 275 extends through the cavitation fitting 255 from the coupling 260 to the upper portion 270 and allows the passage of fluid (e.g., simulated blood) and/or gas (e.g., air) therethrough. In this regard, the upper portion 270 of the cavitation fitting 255 includes a plurality of slits 280 defined by a plurality of fingers 285 (see, e.g., FIGS. 3-5). In this regard, the plurality of slits 280 of the cavitation fitting 255 is configured to produce bubbles and cavitation noises (e.g., sucking noises) as the simulated blood is circulated to and from the chest wound assembly 230. For example, simulated blood, capable of creating bubbles, may be propelled to the chest wound assembly from a reservoir 220 by a pump 205. As the simulated blood traverses the system, air trapped within upper portion 270 (e.g., as a result of the plurality of slits 280) of the cavitation fitting 255 produces bubbles, creating a dynamic bubbling effect commonly associated with open chest wounds. During a suction phase of the pump 205, a mixture of air and blood may be drawn back into a reservoir 295 within the chest wound assembly and/or an associated reservoir (e.g., a coiled tubing reservoir 295 coupled to the chest wound assembly 230 as shown in FIG. 6). In some aspects, it has been observed that the quantity of bubbles generated by the chest wound assembly 230 is associated with (e.g., directly proportional or otherwise related) to the number of slits 280 in the cavitation fitting 255. In some aspects, the number of slits 280 is any value between 4 slits and 100 slits, including any associated range of values (e.g., 6-12 slits, 7-9 slits, 5-15 slits, 4-100slits, or otherwise), though fewer or more slits may be used in some circumstances.

The chest wound assemblies of the present disclosure offer several advantages that enhance medical training and education. Firstly, the chest wound assemblies provide a highly realistic simulation of open chest wounds, replicating the distinctive cavitation noises and bubbling effects that occur when external air enters the pleural space. This realism is crucial for training medical personnel to recognize and respond to such injuries accurately. Additionally, the design allows for adjustable realism and ensures that the wound remains realistic over extended training sessions, providing consistent and reliable practice opportunities. Furthermore, the versatility of the chest wound assembly allows it to be used in a wide range of training scenarios, from civilian accidents to military combat situations, making it an invaluable tool for medical education across various contexts. The realistic chest wound assemblies enhance the training experience, preparing medical trainees to handle real-life open chest wound situations with greater confidence and competence.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

1. A patient simulator, comprising:
a simulated torso having a recess; and
a chest wound assembly positioned within the recess of the simulated torso, the chest wound assembly comprising a cavitation fitting having a plurality of fingers defining a plurality of slits in communication with an opening of the chest wound assembly, the cavitation fitting in fluid communication with a reservoir of simulated blood and configured to produce bubbles and cavitation noises as the simulated blood is circulated to and from the chest wound assembly.

2. The patient simulator of claim 1, further comprising:
a pump in communication with the reservoir of simulated blood, wherein the pump is configured to circulate the simulated blood between the reservoir and the chest wound assembly.

3. The patient simulator of claim 2, wherein the pump is a positive displacement pump.

4. The patient simulator of claim 3, wherein the positive displacement pump is configured to draw in a mixture of air and blood into a volume associated with the chest wound assembly during a suction cycle.

5. The patient simulator of claim 4, wherein the volume includes a coiled tubing reservoir coupled to the chest wound assembly.

6. The patient simulator of claim 4, wherein the volume includes a reservoir within the chest wound assembly.

7. The patient simulator of claim 1, wherein the plurality of fingers define a plurality of slits between 5 slits and 15 slits.

8. The patient simulator of claim 1, wherein the opening extends from the cavitation fitting through a simulated skin layer to a simulated skin surface of the chest wound assembly.

9. The patient simulator of claim 8, wherein the simulated skin layer and the cavitation fitting are coupled to a base component, wherein the base component is sized and shaped to fit within the recess of the simulated torso.

10. A chest wound assembly for a patient simulator, the chest wound assembly comprising:
a base component;
a cavitation fitting coupled to the base component, the cavitation fitting having a plurality of fingers defining a plurality of slits; and
a skin layer coupled to the base component and the cavitation fitting, wherein an opening extends through the skin layer from a simulated skin surface to the cavitation fitting;
wherein the cavitation fitting is configured to be in fluid communication with a reservoir of simulated blood and configured to produce bubbles and cavitation noises as simulated blood is circulated to and from the chest wound assembly.

11. The chest wound assembly of claim 10, further comprising:
a pump configured to be in communication with the reservoir of simulated blood, wherein the pump is configured to circulate the simulated blood between the reservoir and the chest wound assembly.

12. The chest wound assembly of claim 11, wherein the pump is a positive displacement pump.

13. The chest wound assembly of claim 12, wherein the positive displacement pump is configured to draw in a mixture of air and blood into a volume associated with the chest wound assembly during a suction cycle.

14. The chest wound assembly of claim 13, wherein the volume includes a coiled tubing reservoir coupled to the chest wound assembly.

15. The chest wound assembly of claim 13, wherein the volume includes a reservoir within the chest wound assembly.

16. The chest wound assembly of claim 10, wherein the plurality of fingers define a plurality of slits between 5 slits and 15 slits.

17. The chest wound assembly of claim 10, wherein the base component is sized and shaped to fit within a recess of the patient simulator.

18. The chest wound assembly of claim 10, further comprising the reservoir of simulated blood.
